(19) United States
(12) Patent Application Publication
(10) Pub. No.: US 2011/0145115 A1
(43) Pub. Date: Jun. 16, 2011

(54) CUSTOMIZED CONTENT BILLING MANAGEMENT SERVER AND METHOD

(75) Inventors: Eun-Joo KIM, Seoul (KR); Yool Kwon, Incheon-si (KR); Young-Boo Kim, Gongju-si (KR)

(73) Assignee: Electronics and telecommunications Research Institute, Daejeon-si (KR)

(21) Appl. No.: 12/902,688

(22) Filed: Oct. 12, 2010

(30) Foreign Application Priority Data
Dec. 15, 2009 (KR) 10-2009-0124649

(51) Int. Cl. G06Q 30/00

(52) U.S. Cl. 705/34

(57) ABSTRACT

Provided is a customized billing method for content service. A content service billing method in a billing management server for charging a fee for use of content service provided to a user via a communication network includes collecting billing information for calculating a content service use fee for a user from a network switch and a policy control server, and calculating the content service use fee using the collected billing information. Accordingly, customized billing considering communication network performance, service quality, and content properties is feasible.

### CROSS-REFERENCE TO RELATED APPLICATION

This application claims the benefit under 35 U.S.C. §119(a) of Korean Patent Application No. 10-2009-0124649, filed on Dec. 15, 2009, the disclosure of which is incorporated herein in its entirety by reference.

### BACKGROUND

1. Field

The following description relates to a variety of content services provided in a communication network environment, and more particularly, to technology for billing content services.

2. Description of the Related Art

Examples of currently provided contents include voice over Internet protocol (VoIP) content, real-time on-line service, video on demand (VoD), Internet protocol television (IPTV), and file transfer. Quality-based voice services include VoIP premium and VoIP best effort service. Real-time on-line services include video telephone, game, conference, music and so on. The real-time on-line services include a video streaming service, a real-time video download service, a general data service and so on. Billing methods for these contents include a pay per view method, a time-rate method, and a flat-rate method. The pay per view billing method is based on an amount of delivered packets rather than the content of packets. The time-rate billing method is based on a use time rather than the content or amount of packets. As a representative example, the time-rate billing method is applied to a telephone fee. The flat-rate billing method is based on a contract rather than the packet amount and the use time. The flat-rate billing method is applied to most providers. A representative example of the flat-rate billing method is an Internet service (e.g., very-high-speed digital subscriber line; VDSL).

### SUMMARY

As services on the Internet evolve into a variety of services according to communication quality, there is a need for a customized billing scheme which considers network performance, service quality, and content properties. Accordingly, the following description relates to a content service billing method which considers network performance, service quality, and content properties.

According to an exemplary aspect, there is provided a content service billing method in a billing management server for charging a fee for use of content service provided to a user via a communication network, the method including: collecting billing information for calculating a content service use fee for the user from a network switch and a policy control server; and calculating the content service use fee using the collected billing information. The billing management server collects billing information for a content fee and a content data transfer amount from the network switch and billing information for a content data transfer path from the policy control server. The billing management server combines the content fee, a path fee for the content data transfer path, and a pay per view fee for a content data transfer amount to calculate the content service use fee.

According to another exemplary aspect, there is provided a content service billing method performed in a policy control server to charge a fee for use of content service provided to a user via a communication network, the method including: transmitting deep packet inspection information to a network switch; setting a transfer path of content via the network switch; transmitting information on the set transfer path to the network switch; and transmitting billing information for setting of the transfer path to a billing management server.

According to still another exemplary aspect, there is provided a content service billing method performed in a network switch to charge a fee for use of content service provided to a user via a communication network, the method including: receiving deep packet inspection information from a policy control server; recognizing a content fee included in a signature of content using the received deep packet inspection information; recognizing a content data transfer amount; and transmitting billing information for the recognized content fee and the recognized content data transfer amount to a billing management server.

According to yet another exemplary aspect, there is provided a billing management server for charging a fee for use of content service provided to a user via a communication network, the server including; a billing information collector collecting billing information for a content fee, a path fee for a content data transfer path, and a pay per view fee for a content data transfer amount; and a charge calculator combining the content fee, the path fee, and the pay per view fee based on the collected billing information to calculate a content service use fee.

Other features and aspects will be apparent from the following detailed description, the drawings, and the claims.

### BRIEF DESCRIPTION OF THE DRAWINGS

FIG. 1 is a reference diagram illustrating a billing scheme in which a network operator and a content service provider are separately dealt with.

FIG. 2 is a reference diagram illustrating a billing scheme proposed by the Parlay Group.

FIG. 3 illustrates a configuration of an entire system for explaining a content service billing scheme according to an exemplary embodiment of the present invention.

FIG. 4 illustrates an IP packet format including a signature, which includes, for example, ratings and prices of contents.

FIG. 5 is a block diagram of a billing management server according to an exemplary embodiment of the present invention.

FIG. 6 is a reference diagram for explaining a concept of a detailed path billing system which considers communication network performance, service quality and so on according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

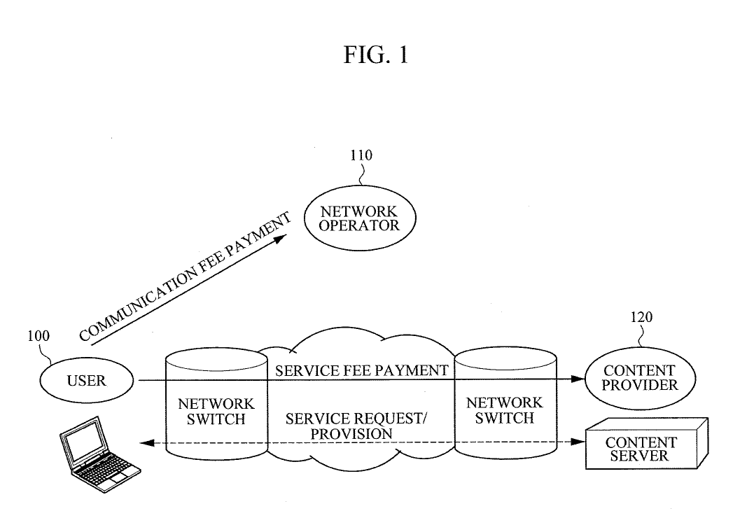

FIG. 1 is a reference diagram illustrating a billing scheme in which a network operator and a content service provider are separately dealt with.

A user 100 separately pays a network use fee and a content service use fee. That is, the user 100 pays a communication fee to the network operator 110, and separately pays the content service use fee to a content provider 120. In a general paid content mall, a fee is charged through day-based billing or content-based billing. When the content is used, a price of the content is displayed. In the case of the day-based billing scheme, the content is allowed to be used unlimitedly for 24 hours after a fee is paid. In the content-based billing scheme, billing is performed for the price of each content.

However, such schemes are not suitable for a recent environment in which there are numerous content service providers and a variety of content services. According to the scheme of FIG. 1, users must suffer the inconvenience of paying a fee for every use of content service. Further, users must pay a fee for the entire content, instead of paying a fee for a used amount of content. The scheme of FIG. 1 may be used to bill for seamless fixed mobile convergence service. For example, when a terminal receiving a content service is changed, content (e.g., a size and a type of the content), a communication method (e.g., a wired/wireless path), and a network operator may be changed. Nevertheless, there is no integrated billing method for services. In addition, when an error is generated during service use, it is necessary to determine whether the error is caused by a network or a content server.

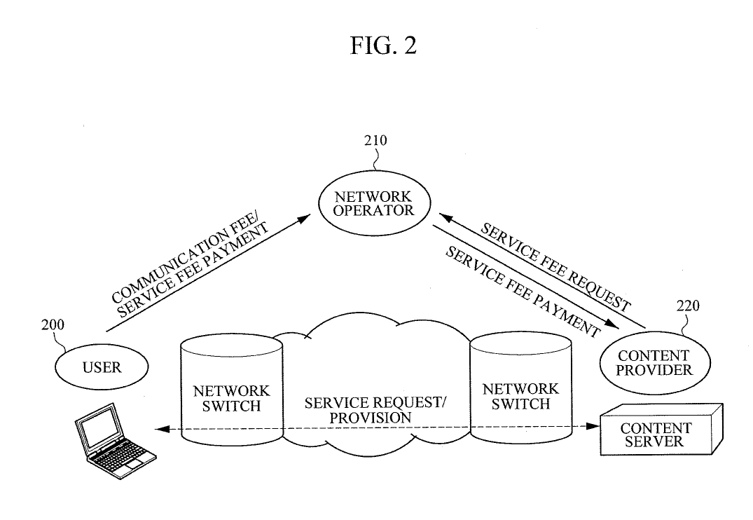

FIG. 2 is a reference diagram illustrating a billing scheme proposed by the Parlay Group.

In a standard billing scheme proposed by the Parlay Group, a network operator charges both a communication fee and a content service fee. According to this scheme, when an error is generated during content service, a user may complain to the network operator. In the scheme, a content provider 220 signs a contract with the network operator 210 in advance, and a user 200 pays both of the communication fee and the service fee to the network operator 210. That is, when a content service is requested, the content provider 220 charges a content service fee to the network operator 210 using an application programming interface (API), and the network operator 210 charges both a communication fee and a service fee to the user 200, and distributes part of a received fee to the content provider 220. When the content provider is a small or medium enterprise, this method guarantees stability of service for the enterprise and facilitates business of the enterprise. However, in this billing scheme, billing is performed in a service unit. Accordingly, when the user uses a streaming service, billing is unreasonable to the user.

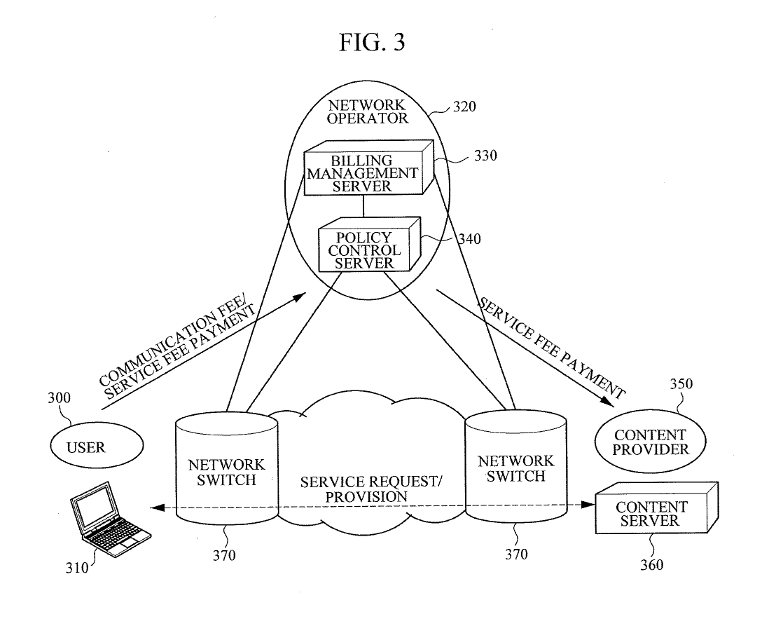

FIG. 3 illustrates a configuration of an entire system for explaining a content service billing scheme according to an exemplary embodiment of the present invention.

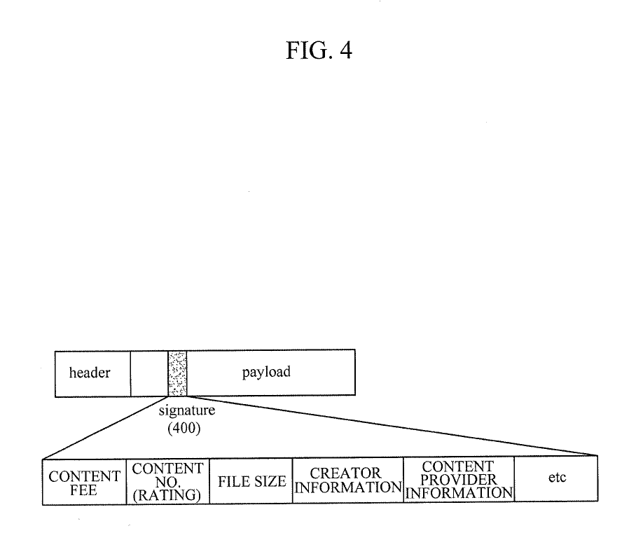

A user 300 refers to a user of a communication terminal, including a mobile terminal. A user terminal 310 is a terminal capable of IP communication and enables the user to use content service. A network operator 320 operates a policy control server 340 and a billing management server 330. The policy control server 340 and the billing management server 330 are connected to a network switch 370. A content provider 350 operates a content server 360 to provide contents to the user 300. The network operator 320 signs a contract for a content service fee with the content provider 350 in advance. The user 300, when using the content service, pays both a communication fee and a content service fee to the network operator 320. A content service fee payment method may be determined according to a policy of the network operator 320. For example, a method of paying summed use fee monthly may be determined instead of content-based billing. The network operator 320 pays a content service fee to the content provider 350 according to a contract condition agreed upon with the content provider 350. Meanwhile, the content provider 350 records content information (e.g., ratings and prices of contents) in a signature through the contract with the network operator 320. FIG. 4 illustrates an IP packet format including a signature, which includes, for example, ratings and prices of contents. The signature 400 including the content information is located within a payload of a content data packet. The signature 400 may include a variety of information, such as a file size, content creator information, and content provider information.

Using a deep packet inspection (DPI) function provided from the policy control server 340, the network switch 370 may recognize the content signature, recognize a data transfer amount for each sub-rating of content, and analyze a variety of protocols (e.g., HTTP, FTP, DNS, and TELNET) supported by an upper application layer. Accordingly, the network switch 370 can collect billing information for contents. Here, the billing information refers to a content fee and a content data transfer amount. The billing information collected by the network switch 370 using the DPI function is transmitted to the billing management server 330. The policy control server 340 determines a content transfer path in consideration of communication network performance, data quality, a provided path and so on. The policy control server 340 transmits the determined path information to the network switch 370, and transmits billing information for the path to the billing management server 330.

The billing management server 330 calculates a content service use fee to be charged to the user 300 using the billing information (content fee and data transfer amount information) delivered from the network switch 370 and the billing information (set path information) delivered form the policy control server 340. According to an aspect of the present invention, the billing management server 330 applies a detailed customized billing system which considers network performance, service quality, a data amount, content properties and so on to calculate the content service use fee. The customized billing system includes a path fee, a content fee, and a pay per view fee. Since high-quality services and low-quality services can be provided according to content transfer paths, a different fee for a path must be applied. This fee is called a path fee. The content fee refers to the price of content provided by the content server 360. The pay per view fee refers to a fee determined by a data amount delivered via the network irrespective of content of content data. The billing management server 330 calculates the path fee based on the set path information and the pay per view fee based on content data transfer amount information, and combines the path fee, the content fee, and the pay per view fee to calculate the content service use fee to be charged to the user 300.

Hereinafter, a content service billing process according to an exemplary embodiment will be described with reference to FIG. 3.

The user terminal 310 is subjected to an authentication process upon initial access to the network. The network switch 370 permits the authenticated user terminal 310 to access the content server 360 so that the authenticated user terminal 310 easily accesses the content server 360 contracted with the network operator 320. When the user terminal 310 accesses the content server 360 and requests a content service, the content server 360 transmits the requested content to the user terminal 310. In this case, the network switch 370 senses a content signature transmitted to the user terminal 310 using the DPI function, and measures a content data transfer amount. In addition, the network switch 370 generates billing information including a data transfer amount and a content fee and transmits the billing information to the billing management server 330. The policy control server 340 provides DPI information to the network switch 370, and performs service provision according to a rating (high quality/low quality) of content passing through the network switch 370 and path setting. The policy control server 340 transmits the set content path information to the network switch 370. The policy control server 340 also transmits billing information related to the content rating and path setting to the billing management server 330.

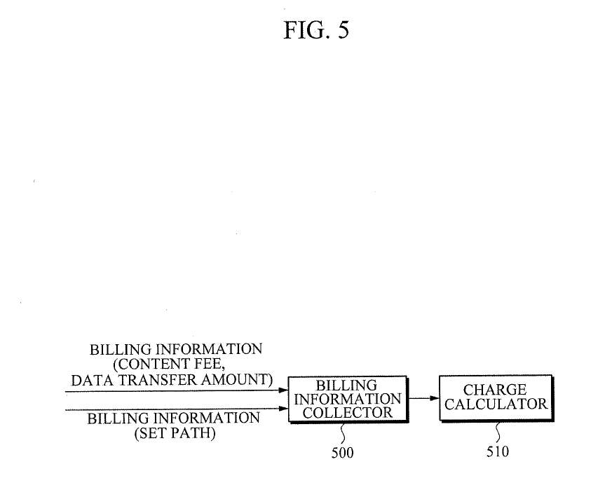

The billing management server 330 includes a billing information collector 500 and a charge calculator 510, as shown in FIG. 5. The billing information collector 500 collects billing information (including the content fee and the data transfer amount) from the network switch 370 and billing information (including the content rating and the path information) from the policy control server 340. The charge calculator 510 calculates the content service use fee for the user terminal 310 using the billing information collected by the billing information collector 500. In an aspect of the present invention, the charge calculator 510 combines the path fee, the content fee, and the pay per view fee to calculate the content service use fee. The billing management server 330 charges the calculated content service use fee to the user 300, and the user 300 pays the charged content service use fee to the network operator 320. The network operator 320 pays the service fee to the content provider 350 according to a contract condition agreed upon with the content provider 350.

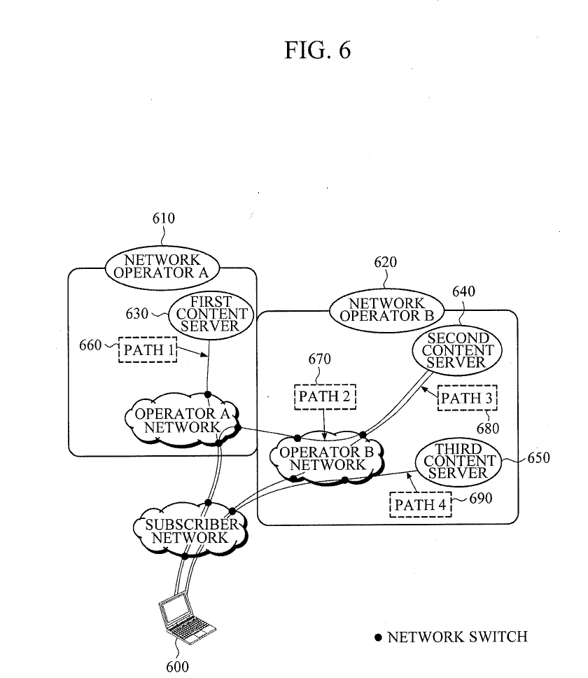

FIG. 6 is a reference diagram for explaining a concept of the detailed path billing system which considers communication network performance, service quality and so on according to an exemplary embodiment of the present invention.

When a user terminal 600 uses a content service provided by a first content server 630, path 1 660 is provided as a data delivery path. Path 1 660 is a path via a single communication network of network operator A 510. Even in the single communication network path, high-quality/low-quality content services can be provided and thus different path fees can be applied.

When the user terminal 600 uses a content service provided by a second content server 640, path 2 670 and path 3 680 are provided as data delivery paths. Path 2 670 includes paths of different network operators 610 and 620. A network switch may compare a path 2 670 use fee with a path 3 680 use fee to provide the most suitable path to the user terminal 600. When desired content is in both of the second content server 640 and a third content server 650, path 3 680 and path 4 690 are provided as data delivery paths via a communication network of network operator B 620. In this case, different path fees may be applied according to, for example, communication network performance and a path length.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A content service billing method in a billing management server for charging a fee for use of content service provided to a user via a communication network, the method comprising:
collecting billing information for calculating a content service use fee for the user from a network switch and a policy control server; and
calculating the content service use fee using the collected billing information.

2. The method of claim 1, wherein the collecting of the billing information comprises collecting billing information for a content fee and a content data transfer amount from the network switch.

3. The method of claim 1, wherein the collecting of the billing information comprises collecting billing information for a content data transfer path from the policy control server.

4. The method of claim 3, wherein the calculating of the content service use fee comprises combining the content fee, a path fee for the content data transfer path, and a pay per view fee for a content data transfer amount to calculate the content service use fee.

5. A content service billing method performed in a policy control server to charge a fee for use of content service provided to a user via a communication network, the method comprising:
transmitting deep packet inspection information to a network switch;
setting a transfer path of content via the network switch;
transmitting information on the set transfer path to the network switch; and
transmitting billing information for setting of the transfer path to a billing management server.

6. A content service billing method performed in a network switch to charge a fee for use of content service provided to a user via a communication network, the method comprising:
receiving deep packet inspection information from a policy control server;
recognizing a content fee included in a signature of content using the received deep packet inspection information;
recognizing a content data transfer amount; and
transmitting billing information for the recognized content fee and the recognized content data transfer amount to a billing management server.

7. A billing management server for charging a fee for use of content service provided to a user via a communication network, the server comprising:
a billing information collector collecting billing information for a content fee, a path fee for a content data transfer path, and a pay per view fee for a content data transfer amount; and
a charge calculator combining the content fee, the path fee, and the pay per view fee based on the collected billing information to calculate a content service use fee.

8. The server of claim 7, wherein the billing information collector collects billing information for a content fee and a pay per view fee from a network switch.

9. The server of claim 7, wherein the billing information collector collects billing information for a path fee from a policy control server.
